(19) United States
(12) Patent Application Publication
(10) Pub. No.: US 2013/0305557 A1
(43) Pub. Date: Nov. 21, 2013

(54) SYSTEM FOR USING HEAT TO PROCESS AN AGRICULTURAL PRODUCT, A FLUIDIZED BED COMBUSTOR SYSTEM, AND METHODS OF EMPLOYING THE SAME

(71) Applicant: ARCHER DANIELS MIDLAND COMPANY, Decatur, IL (US)

(72) Inventor: Glenn D. Kimball, Fairfax, IA (US)

(73) Assignee: ARCHER DANIELS MIDLAND COMPANY, Decatur, IL (US)

(21) Appl. No.: 13/950,391

(22) Filed: Jul. 25, 2013

Related U.S. Application Data
(63) Continuation of application No. 12/114,347, filed on May 2, 2008, now abandoned.
(60) Provisional application No. 60/927,359, filed on May 3, 2007.

(51) Int. Cl. F26B 23/02; F26B 25/14; F23C 10/10; F26B 3/20; F23C 10/00

(52) U.S. Cl. CPC F26B 23/028; F26B 3/20; F23C 10/002; F23C 10/10; F26B 25/14
USPC 34/345; 34/79; 110/245

(57) ABSTRACT

Systems and related methods of using heat to process an agriculture/product are provided. The system comprises a circulating fluidized bed combustor, a first conduit system, and an indirect heating dryer. The circulating fluidized bed combustor comprises a combustion chamber configured to combust a fuel to generate a mixture comprising hot gases and particulate matter, and a separation chamber configured to separate at least a portion of the particulate matter from the mixture to form a flow of cleaned hot gas. The first conduit system is configured to conduct the cleaned hot gas to a heat exchanger. The indirect heating dryer is in heat conductive contact with the heat exchanger and configured to use the heat from the cleaned hot gas to indirectly dry the agricultural product without contacting the agricultural product with the cleaned hot gas. The system and methods provide hot gas for efficient and low cost energy formed from alternative and lower cost fuels, including biomass sources, and allows for flexibility and efficiency in numerous manufacturing processes.

### CROSS REFERENCE TO RELATED APPLICATIONS

The application claims the priority benefit of U.S. Patent Application No. 60/927,359, filed May 3, 2007, the disclosure of the entirety of which is incorporated by this reference.

### TECHNICAL FIELD

The present disclosure is directed to a system for using heat to process an agricultural product, a fluidized bed combustor system, and methods of employing the same.

### BACKGROUND

Environmental concerns and the control of solid, liquid and gaseous effluents or emissions are important elements in the design of steam generating systems, such as those employing circulating fluidized beds, that use the heat produced from the combustion of fossil fuels to generate steam. Thus, conventional circulating fluidized bed combustors are integrated into a boiler design where walls of the combustion chamber are lined with high pressure conduits carrying water that absorbs the combustion heat and is converted into super heated steam. The superheated steam is then piped from the boiler to other sections of a plant where the heat energy is used for other downstream processes such as driving turbines to produce electricity, or for heating or product drying applications. To build-in and contain the steam conduits, the configuration of a conventional circulating fluidized bed combustor is generally rectilinear, with straight walls engaging one another orthogonally at the corners with the water conduits engaged within the walls. While rectilinear designs may be efficient for the manufacture of circulating fluidized bed combustors for use as boilers, rectilinear combustor designs have certain draw backs, such as being complicated to assemble and creating fluid flow inconsistencies in the corner sections were the walls meet. Moreover, the high pressure generated in the superheated steam conduits creates safety hazards that must be carefully managed.

Nevertheless, these circulating fluidized bed boiler systems are employed in evolving technologies to generate efficient and low-cost electricity with very low emissions and environmental impact. At present, the most significant of these emissions are sulfur dioxide (SO₂), oxides of nitrogen (NOₓ), and airborne particulate. NOₓ refers to the cumulative emissions of nitric oxide (NO), nitrogen dioxide (NO₂) and trace quantities of other species generated during combustion. Once the fuel source is chosen, NOₓ emissions are minimized using low NOₓ combustion technology and post-combustion techniques.

In a circulating fluidized bed combustion process, for example, crushed coat is mixed with limestone and fired in a process resembling a boiling fluid. The addition of limestone removes the sulfur and converts it to an environmentally benign powder that is removed with the ash. Reacting and non-reacting solids are entrained within a reactor enclosure by an upward gas flow which carries the solids to an exit at an upper portion of the reactor enclosure. There, the solids are typically collected by e primary particle separator, of impact type or cyclone type. The impact type primary particle separator at the reactor enclosure exit typically collects from 90% to 97% of the circulating solids.

It has been found that fluidized bed combustion has distinct advantages for burning solid fuels and recovering energy to produce steam. Typically, fluidized bed combustion can be used to burn high sulfur coals and achieve low SO₂ emission levels without the need for additional sulfur removal equipment. Fluidized had boilers have been designed so that the bed operating temperature is between 1500° F. and 1600° F. (816° C. and 871° C.), resulting in relatively low NOₓ emissions. These lower operating temperatures also permit combustion of lower grade fuels (which generally have high slagging and fouling characteristics) without experiencing many of the operational difficulties which normally occur when such fuels are burned.

Although conventional systems employing circulating fluidized beds have proven to be a useful means to produce efficient and low-cost electricity with very low emissions in a boiler design, the need exists for continued development and advancement in circulating fluidized bed technology. Further advancement in the area is needed to provide systems that are more efficient, use alternative and lower cost fuels, and/or reduce equipment costs.

### SUMMARY

The present disclosure addresses the above-mentioned need by providing a system for using heat to process an agricultural product, a fluidized bed combustor system that is not used in a boiler configuration, but rather directly uses the hot gases generated from fuel combustion for downstream processing needs, and methods of employing the same. The absence of water containing conduits containing superheated steam in the walls of the combustion chamber permits use of a cylindrical combustor design that reduces the cost of manufacturing and also provides enhanced safety by eliminating the need for high pressure steam conduits.

In one aspect, the present disclosure describes a circulating fluidized bed hot gas generation system that includes a cylindrical combustion chamber and a cyclonic air flow separation chamber. The cylindrical combustion chamber is configured to combust a fuel to generate a mixture comprising hot gases and particulate matter that is devoid of contact between the hot gases and a water containing conduit, i.e., the combustor need not be integrated with a boiler. The cyclonic air flow separation chamber is in fluid connection with the combustion chamber and configured to separate at least a portion of the particulate matter from the mixture to form a first flow of cleaned hot gas that is conducted away from the cyclonic air flow chamber and combustion chamber, and to return the separated particulate matter to the combustion chamber.

In another aspect, described herein is a system for using heat to process an agricultural product. The system comprises a circulating fluidized bed combustor hot gas generator, a first conduit system, and an indirect heating dryer. The circulating fluidized bed combustor comprises a combustion chamber configured to combust a fuel to generate a mixture comprising hot gases and particulate matter, and a separation chamber configured to separate at least a portion of the particulate matter from the mixture to form a flow of cleaned hot gas. The first conduit system is configured to conduct the cleaned hot gas to a heat exchanger. The indirect heating dryer is in heat conductive contact with the heat exchanger and configured to use the heat from the cleaned hot gas to indirectly dry the agricultural product without contacting the agricultural product with the cleaned hot gas.

In one embodiment, the present disclosure provides a continuous system for using heat to process an agricultural product, comprising a circulating fluidized bed combustor, a first conduit system, and an indirect heating dryer. The circulating fluidized bed combustor comprises a combustion chamber configured to combust a fuel to generate a mixture containing hot gases and particulate matter, and a separation chamber. The separation chamber is configured to separate at least a portion of the particulate matter from the mixture to form a flow of cleaned hot gas and further comprises a return conduit that is configured to return at least a portion of the separated particulate matter to the combustion chamber. The first conduit system is configured to conduct the cleaned hot gas to a heat exchanger. The indirect heating dryer is in heat conductive contact with the heat exchanger and configured to use the heat from the cleaned hot gas to indirectly dry the agricultural product without contacting the agricultural product with the cleaned hot gas. In this embodiment, a hot water vapor is produced in the indirect heating dryer, and the system further includes a second conduit system configured to conduct the hot water vapor from the indirect dryer to a second heat exchanger configured to provide heat for further processing.

Also provided is a method of employing heat to process an agricultural product. The method comprises combusting a fuel in a circulating fluidized bed combustor comprising a combustion chamber configured to combust a fuel to generate a mixture comprising hot gases and particulate matter, and a separation chamber configured to separate at least a portion of the particulate matter from the mixture to form a flow of cleaned hot gas, to generate a mixture containing hot gases and particulate matter. The method further comprises separating at least a portion of the particulate matter from the mixture to form a flew of cleaned hot gas, conducting the cleaned hot gas to a heat exchanger, and indirectly drying the agricultural product with the cleaned hot gas without contacting the agricultural product with the cleaned hot gas.

It should be understood that this invention is not limited to the embodiments disclosed in this Summary, and it is intended to cover modifications that are within the spirit and scope of the invention, as defined by the claims.

### BRIEF DESCRIPTION OF THE DRAWINGS

The foregoing Summary, as well as the following Detailed Description, will be better understood when read in conjunction with the appended drawings. In the drawings:

FIG. 1 is a schematic side elevation view of the system of the present disclosure;

FIG. 2 is a side elevational view of the circulating fluidized bed combustor of the present disclosure;

FIG. 3 is a side elevation& view of the circulating fluidized bed combustor of the present disclosure as identified in FIG. 1;

FIG. 4 is a top plan view of the circulating fluidized bed combustor of the present disclosure;

FIG. 5 is a perspective view of the circulating fluidized bed combustor of the present disclosure; and

FIG. 6 is a perspective view of the circulating fluidized bed combustor of the present disclosure.

### DETAILED DESCRIPTION

It is to be understood that certain figures and descriptions of the present disclosure have been simplified to illustrate only those elements that are relevant to a clear understanding of the present disclosure, while eliminating, for purposes of clarity, other elements. Those of ordinary skill in the art will recognize that other elements may be desirable in order to implement the present disclosure. However, because such other elements are well known in the art, and because they do not facilitate a better understanding of the present disclosure, a discussion of such elements is not provided herein.

Other than in the operating examples, or unless otherwise expressly specified, all of the numerical ranges, amounts, values and percentages, such as those denoting amounts of materials, times and temperatures of reaction, ratios of amounts, and others in the following portion of the specification, may be read as if prefaced by the word “about,” even though the term “about” may not expressly appear with the value, amount or range. Accordingly, unless indicated to the contrary, the numerical parameters set forth in the following specification and attached claims are approximations that may vary depending upon the desired properties sought to be obtained by the disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding the fast that the numerical ranges and parameters setting forth the broad scope of the disclosure are approximations, the numerical values set forth in the specific examples are reported as precisely as possible. Any numerical values, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Also, it should be understood that any numerical range recited herein is intended to include all sub ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. In addition, the terms “one,” “a,” or “an” as used herein are intended to include “at least one” or “one or more,” unless otherwise indicated.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

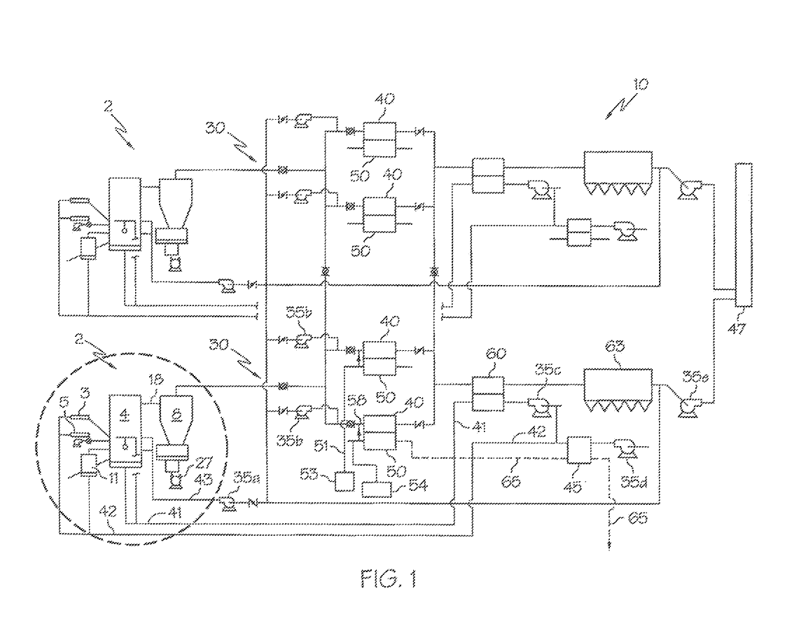

Turning now to the drawings, FIG. 1 is a schematic representation of one embodiment of the present teaching, which is a system 10 for using heat in the form of hot gases rather than steam to process an agricultural product, and methods of employing the same. System 10 may be any suitable processing system, such as a continuous system 10, as illustrated. For example, the system 10 may be an agricultural processing plant such as, for example, a corn wet milling plant or a corn dry milling plant. Generally, the system 10 comprises a circulating fluidized bed combustor 2, a first conduit system 30 configured to conduct a cleaned hot gas from the circulating fluidized bed combustor 2 to a heat exchanger 40, and an indirect heating dryer 50 in heat conductive contact with the heat exchanger 40. As used herein, the phrase “cleaned hot gas” refers to a gas flow from a combustion chamber having a temperature of typically about 1000° F. to 1600° F. where at least 99%, or more typically at least 99.5% of solid materials (ash) present in the combustion chamber has been removed from the gas flow.

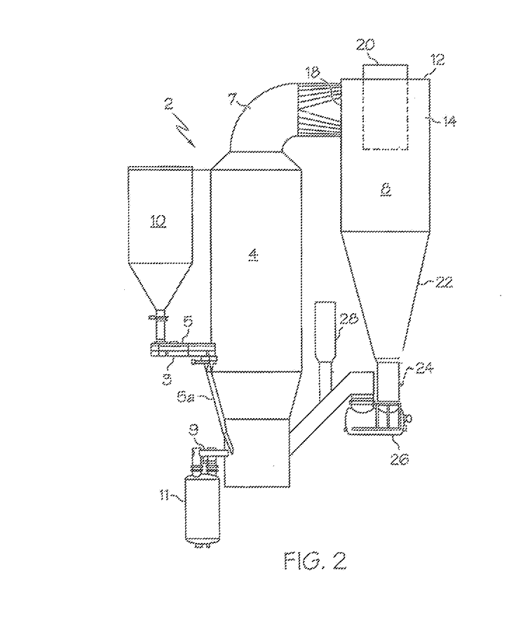

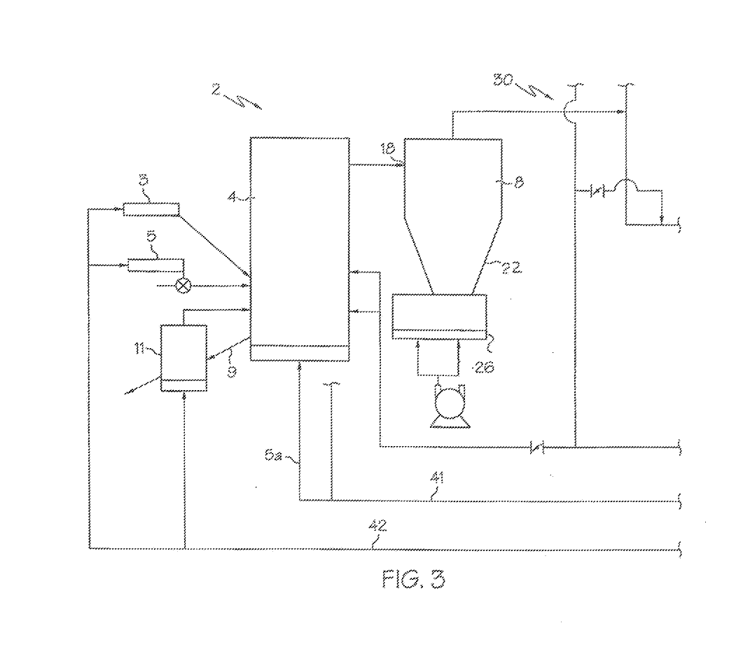

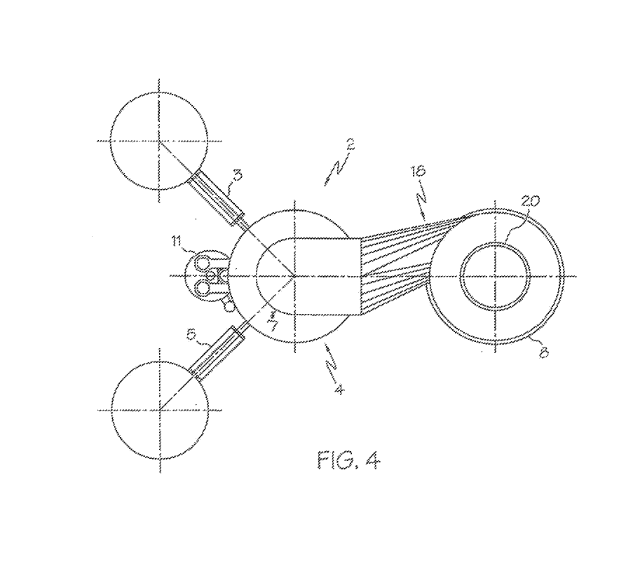

As illustrated in FIGS. 2-6, the combustor 4 portion of the circulating fluidized bed combustor 2 may be any suitable combustor known to those of ordinary skill in the art. For example, combustor 4 may be a combustor commercially available from Metso, Finland. In other embodiments, the combustor portion is unique in having a cylindrical cross section. System 10 may include one or more circulating fluidized bed combustors 2, such as, for example, two or more combustors 2 in series, as illustrated in FIGS. 1, 5 and 6. The circulating fluidized bed combustor 2 disclosed herein provides fuel combustion capabilities as well as separation capabilities to produce the cleaned hot as for use in system 10. In this regard, the circulating fluidized bed combustor 2 has the combustion chamber 4 in fluid communication with a cyclonic separation chamber 8 at an upper portion of the combustor 4 and cyclonic separation chamber 8 via gas flow line 18.

Turning to FIG. 2, as discussed in more detail below, the combustor 4 may include one or more input feed lines 3, 5, 5a for the principle fuel and air sources. Typically the principle fuel source may be coal or natural gas. In addition in a particularly advantageous embodiment, the combustor 4 may also include input feed lines 28 to feed a secondary fuel source, such as plant biomass into the combustor 4. The combustor 4 typically further includes one or more outlet lines 9 for removal of particulate matter, (ash) which is transferred to collection chamber 11. In a typical embodiment, the ash being removed from cutlet line 9 is cooled by airflow 12 before being collected in the collection chamber 11. The circulating fluidized bed combustor 2 also includes outlet conduits 30 for conducting the cleaned hot gas from the cyclonic separation chamber 8 to other portions of the system 10, such as to heat exchanger 40.

As previously mentioned it is contemplated that in addition to the principle fuel sources, fed through one or more feed input lines 3, 5 secondary biomass fuels may also be fed into the circulating fluidized bed system 2 via feed line 28 to provide additional energy to be employed for operation of system 10. For example, in certain non-limiting embodiments of the present disclosure, the secondary fuel source may include, for example, biomass, petroleum-coke, tire scrap, and any combination of at least two thereof. Various biomass materials may be employed for combustion, such as, for example, a wood derived material, a dried waste water material, a dried post-fermentation biomass, an organic stillage, an agriculturally derived material, and combinations of any thereof. Suitable dried post fermentation biomass may include, for example, distillers dried grains. Suitable agriculturally derived materials may include, for example, a dried portion of at least one of soybean, cocoa, oat, corn, wheat, canola, and combinations of any thereof. As used herein, “dried” refers to materials having a moisture content of less than 50% percent by weight, or typically less than 20% by weight or more typically less than 10% by weight. In general, the secondary fuel source is typically dried to remove at least about 60% of its native moisture content. One of ordinary skill in the art will appreciate other suitable biomass fuels that can be employed as a fuel source. In a typical application, the biomass component may include components of corn. Various corn components may be employed in the process of the present disclosure, such as, for example, corn germ, corn starch, corn fiber, corn kernels, corn silk, corn hulls, corn husks, corn stover, corn meal, corn gluten, shelled corn, corn screenings, and combinations of any thereof.

The various components of the fuel source of the present disclosure may provide any desirable portion of the total BTU output or content that is combusted. In certain embodiments, the biomass component provides no greater than 50% of the BTU content of the fuel, while the remaining fuel content comprises at least one of natural gas and coal. In another embodiment the biomass may be a combination of a corn component and coal having a corn to coal BTU ratio in the range of 1:20 to 1:1 In another embodiment, the corn to coal BTU ratio may be at a ratio of approximately 1:1. In an embodiment for a corn processing plant, the total thermal energy flow in system 10 is typically between 300 and 400 million BTUs per hour.

In addition to the fuel source, other feed materials, such as limestone and combustion air may be feed through the input lines 5, 5a, respectively, by means known to those of ordinary skill in the art. For example, the addition of limestone to the process removes sulfur during combustion by converting sulfur to an environmentally benign powder that may be removed with the ash.

The combustion chamber 4 may be any size and configuration suitable to combust the various fuel materials provided herein, and may be configured to combust a fuel to generate a mixture comprising hot gases and particulate matter. As illustrated best in FIG. 2, in one advantageous embodiment, the combustion chamber 4 is a cylindrical chamber. In this form, the combustion chamber 4 may include a top portion 6 and an outlet port 7 concentric with the cylinder located in the top portion 6 to conduct the mixture of particulate matter and hot gases into the separation chamber 8.

The mixture of hot gases and the particulate matter may be any gases and particulate material that are a byproduct of the combustion of the fuel materials or mixtures set forth herein. In the typical embodiments, the hot gases include, for example, air and carbon dioxide, with trace amounts of carbon monoxide and nitrous oxide where biomass is being used as a portion of the fuel. The particulate matter typically includes, for example, a mixture of about 40% bottom ash typically having particles of about 100-5000 microns in size and about 60% fly ash having a particle size typically about 10-200 microns. A majority of the bottom ash and some of the fly ash is removed from combustor 4 via output line 9, while a substantial portion of the fly ash is transferred with the hot gases to an upper portion 14 of the cyclonic separator 8 in a flow direction that is tangential to the wall 12 of the cyclonic separator 8.

The hot gases and particulate matter may be generated at any suitable processing temperature. In one embodiment, for a corn processing facility, the mixture of hot gases and particulate matter may be generated at a temperature ranging from 843° C. to about 899° C. During combustion, a majority of the particulate matter, such as bottom ash, formed from combustion may be removed via line 9 to a bed ash cooler 11, for storage and disposal or further processing tor use in, for example, concrete applications, soil enhancers, and/or landfill. When the fuel source has substantial amounts of biomass, it has been found that ash production may be substantially reduced thereby substantially reducing ash storage and/or disposal requirements which, in certain embodiments, provides additional processing and environmental advantages. Thus for example, when the BTU content is provided 50% from biomass and 50% from coal, the total ash produced is only about 75% of the ash produced from burning coal alone.

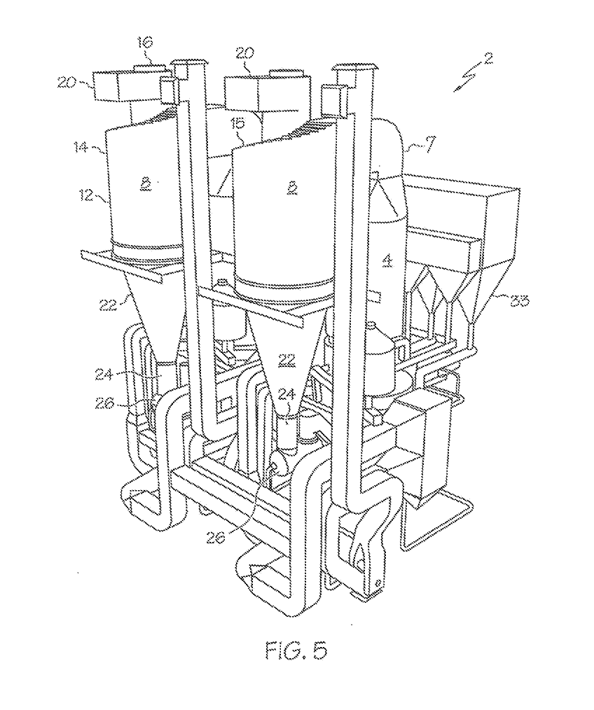

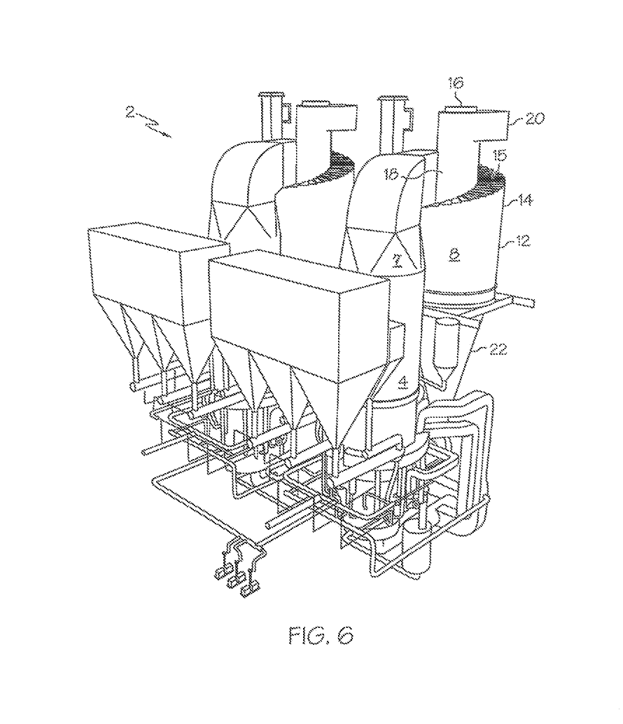

As illustrated in FIGS. 5 and 6, two or more separation chambers 8 may be employed that correspond to an associated combustion chamber 4. The separation chambers 8 may be of any size and configuration suitable to separate at least a portion of the particulate matter from the hot gases to form a flow of cleaned hot gas. In one embodiment, the separation chamber 8 comprises the upper cylindrical portion 14, an inlet port 18, and an outlet port 20. In certain embodiments, the outlet port 20 may be positioned in the roof 15. The inlet port 18 is positioned at an upper portion of the cylindrical portion 14 and configured to receive the mixture of hot gases from the combustion chamber 4. In certain embodiments, the inlet port 18 may be configured to introduce the mixture of particulate matter and hot gases into the cyclonic flow chamber 8 in a direction approximately tangential to the curvature of the cylindrical portion 14. The inlet port 18 may be any size and configuration suitable to receive the mixture of hot gases, but in certain embodiments, the inlet port 18 has a height to width ratio of 1.5:1 or less. The outlet port 20 may be positioned above the inlet port 18 to output the cleaned hot gas.

Referring to FIGS. 2 and 5, the separation chamber 8 may also include a lower cone portion 22 in fluid connection with the upper cylindrical portion 14 with an exit port 24 positioned at a lower portion of the cone portion 22 to conduct the particulate matter back to the combustor 4. The cone portion 22 may be any suitable size or configuration, and in some embodiments has a length at least twice the diameter of the cylindrical portion 14. In certain embodiments, the separation chamber 8 may be further configured to return the separated particulate matter to the combustion chamber 4 via a loop seal 26 in fluid connection between a lower portion of the separation chamber 8 and a lower portion of the combustion chamber 4. In embodiments of the present disclosure, the fuel may be a mixture of coal and biomass, and the system 10 may be configured such that the biomass may be introduced into the combustion chamber 4 via a biomass inlet port 28 positioned after the loop seal 26, while coal may be introduced into the combustion chamber 4 via separate feed input lines 3 on the combustion chamber 4 away from the biomass inlet port

As best shown in FIG. 5, the upper cylindrical portion 14 of the cyclonic separator 8 is advantageously configured with the roof 15 having the helical curvature. In certain embodiments the root 15 is also fluted. Returning to FIG. 2, to describe the general operation of the circulating fluidized bed combustor 2 portion of system 10, as the hot gases from the combustor 4 enter the cyclonic separation chamber 8 in a tangential direction and strikes the helical portion of the roof 15, a cyclonic flow is created that pushes the fly ash outward toward the walls 12 and downward from the upper cylindrical portion 14 to the bottom conical portion 22 of the cyclonic separator 8. To achieve this effect in an efficient manner, the lower conical portion 22 of the cyclonic separator 8 has a length that is at least twice the diameter of the upper cylindrical portion 14. This cyclonic action provides a centrally located stream of cleaned hot gas that is conducted away from the cyclonic separator 8 via output port 20 located in the roof 15, which is in turn connected to conduits 30 to conduct the cleaned hot gases through system 10. As best depicted in FIG. 1, a set of blowers or fans 35(a)-35(d) positioned at various points in system 10 facilitate the flow of cleaned hot gases to a heat exchanger 40 and/or to a distillation apparatus 53 or other heat exchanger 54. In an advantageous embodiment, the has flow through system 13 is conducted at a speed of about 3000 ft/minute. The flow of gases and ash that descends to the bottom portion 22 of the cyclonic separator 8 is returned to a lower portion of the combustor 4 via loop seal 26. The temperature of the cleaned gas entering into the first conduit system may be any desirable temperature for further processing, typically at least 1000° C. an in typical embodiments of the system 10 where the heat will be used for the dual purposes of drying distillers dry grains obtained from an ethanol fermentation broth as well as for providing heat to operating an ethanol distillation apparatus, the entry temperature typically ranges from 1400 to 1600° C.

The heat exchanger 40 and indirect dryer 50 may be any suitable heat exchanger known to those of ordinary skill in the art, such as a heat exchanger commercially available from Barr-Rosin, Boisbriand, Quebec. The heat exchanger 40 may be any size and configuration suitable to transfer heat from the flow of cleaned hot gas to the desired agricultural product via the indirect dryer 50 to indirectly dry the agricultural product without contacting the agricultural product with the cleaned hot gas. The dryer 50 may be any suitable indirect heating dryer known to those of ordinary skill in the art, such as an indirect heating dryer commercially available from Barr-Rosin. The dryer 50 may be any size and configuration suitable to indirectly dry the agricultural product. Although any suitable thermal energy flow may be employed in the system 10 of the present disclosure, in certain embodiments of the present disclosure, a thermal energy flow generated by the indirect heating dryer 50 may be at least 10 million BTUs per hour, and in certain embodiments may be between 300 million and 400 million BTUs per hour.

System 10 may be employed to dry various agricultural products known to those of ordinary skill in the art, such as, for example, those agricultural products derived from at least one of soybean, cocoa, oat, corn, wheat, canola, and combinations of any thereof. In certain embodiments of the present disclosure, the agricultural may be, for example, distillers dried grain, corn germ, corn starch, corn fiber, corn kernels, corn silk, corn hulls, corn husks, corn stover, corn meal, corn gluten, and combinations of any thereof.

In certain embodiments, hot water vapor at a temperature ranging from, for example, 90° C. to 212° C. may be produced in the indirect heating dryer 50. In this embodiment, the dryer 50 may be a closed-loop superheated steam flash dryer system that may be further arranged to include a second conduit system 51 configured to conduct the hot water vapor from indirect dryer 50 to a second heat exchanger 54. The second heat exchanger 54 may be configured to provide a processing heat for producing a second agricultural product. The hot water vapor may also be used directly for further processing, for example, to provide heat to another apparatus, such as, for example, a distillation apparatus 53, a dryer, an evaporator, another heat exchanger, a fluid processing stream, and combinations of any thereof (not shown). For example, system 10 may be employed in certain embodiments wherein the agricultural product comprises distillers dried grains and a second agricultural product comprising, for example, ethanol, wherein a second heat exchanger 54 may be configured to heat the distillation apparatus 53 in which the ethanol may be produced. In another embodiment, system 10 may be employed wherein the agricultural product comprises distillers dried grains and a second heat exchanger 54 may be configured as, for example, an evaporator

A general proposal of one mode for implementing the cleaned hot gas system 10 disclosed herein in a dry mill corn processing plant is depicted in the schemata of FIG. 1. The system 10 depicted in FIG. 1 is proposed as a design for generating 300 to 400 million BTUs per hour of hot gas from tandem circulating fluidized bed hot gas generators 2 that are depicted on the top and bottom sections of FIG. 1. BTU capacity can be increased by adding additional circulating fluidized bed hot gas generators 2, or decreased by using only one. Because the upper and lower sections are identical with respect to a single circulating fluidized bed generator 2, reference will be made only to the bottom portion of FIG. 1 with the understanding that gases and other resources in the system 10 may be passed or otherwise shared between the tandem sections. For ease of understanding, the primary and secondary fuel storage units 33 and 28, respectively, as well as the input of the secondary fuel is omitted from FIG. 1, which emphasizes the flow and uses of hot gases in the system 10.

Beginning at the left of FIG. 1, coal and limestone as principle fuel components are combined via input ports 3 and 5, respectively. and introduced into the combustor 4 of the circulating fluidized bed hot gas generator 2. Air and flue gases are introduced into the combustor at multiple ports located at different heights and radial positions around the combustor 4 as indicate by gas flow lines 41, 42 and 43. A first portion of preheated fresh air 41 obtained from extracting excess heat from used hot gases (described in more detail below) is introduced from the bottom portion of the combustor 4 at various heights via forced draft blower 35c to provide oxygen for combustion and turbulence to fluidize the fuel bed in the combustor 4. A second portion of preheated fresh air 42 obtained from extracting heat removed from a cooler 45 used to cool an agricultural product dried in the system 10 (described in more detail below) is introduced via cooler blower 35d. The fresh air 42 from the cooler is bifurcated, with a first portion being used to cool bottom ash removed from the combustor 4 into ash container 11 before entering the combustor 4, and a second portion being used to pressurize the material combined via the ports 3, 5 before entering the combustor 4. Flue gas 43 is introduced in a mid level position of the combustor 4 via flue gas recirculating fan 35a, and carries a portion of recycled flue gas originating from the circulating fluidized bed system 2 that would otherwise exit the system 10 via chimney stack 47. Flue gas stream 43, being the product of combustion, is anoxic relative to fresh air lines 41 43 and is used along with the fresh air streams 42, 43 to control combustion in the combustor 4.

Hot gases from the combustor 4, along with fly ash exit the combustor 4 via exit port 18 to enter the upper portion of cyclonic separating chamber 8. The particulate ash material that separates to the bottom of the cyclonic separating chamber 8 is fluidized by centrifugal air blower 27 so that it can be reintroduced into the combustor 4 as previously described but not depicted in FIG. 1. The cleaned hot gases exit from the upper portion of the cyclonic separator 8 and flows into gas conduits 30. In the tandem system depicted in FIG. 1, the cleaned hot gases (flue gases) from different circulating fluidized bed combustor systems 2 may be blended and propelled through system 10 via flue gas blending fans 35b. In any case, a fan 35b is used to draw the cleaned hot gases through the system 10. The cleaned hot gases are passed into indirect heat exchanger 40, which is configured with agricultural product dryers 50. Heat from the cleaned hot flue gases is transferred to the dryer 50 without contacting the agricultural product, generating steam in dryer 50. A first portion of the steam generated in the dryer 50 is conducted via steam conduit 51 to a second heat exchanger 54 or heat using apparatus, such as ethanol distillation apparatus 53. A second portion of the steam from the dryer 50 is recirculated back into the dyer 50 via steam recirculating conduit 58.

The cleaned hot gases leaving the heat exchanger 40/dryer 50 apparatus, now having transferred thermal energy to dry the agricultural product exit the dryer 50 at a reduced temperature, typically for example approximately 466° C. Heat from the exiting gas is passed into another indirect heat exchanger, in this case air heater 60 where thermal energy is transferred to fresh air, which in turn is conducted into the combustor 4 via air conduit 41. As depicted, the fresh air heated by air heater 60 has first been preheated by absorbing heat from the agricultural product that has been dried in dryer 50 and conveyed to a cooler 45 via conveyor 65. Ambient air is drawn into cooler 45 by cooler fan 35d. A first portion of the air emerging from the cooler 45 is drawn into the air heater 60 to increase its heat before being conducted to the combustor 4 via fresh air line 41, while a second portion in air conduit 42 (at a cooler temperature than fresh air line 41) is used to cool the ash in ash container 11 and to apply pressure to the material combined from fuel ports 3 and 5 before entering the combustor 4.

The cleaned hot flue gases exiting air heater 60, now depleted of most of its thermal energy passes into baghouse 63, where it is filtered of remaining particulate matter before being passed into chimney 47 for exiting system 10 as exhaust, which may be facilitated by exhaust fan 35e. Meanwhile, a portion of the dried and cooled agricultural product can be conducted by conveyor 65 for use as the secondary fuel source for combustor 4, or transported to another location for storage.

As will be recognized by one of ordinary skill in the art, many aspects of the agricultural product system 10 described herein can be monitored and adjusted with respect to one another to coordinately control temperature, heat transfer, fuel transfer and flow processes, so as to optimize the efficiency of thermal energy usage in a corn milling and ethanol production plant, or any other agricultural product processing facility where heat is generated and used for multiple purposes. One of the principle advantages of the hot gas generation and heat transfer system 10 described herein is that it avoids the high thermal cost of transferring heat to water to make steam, while at the same time maximizing use of the lower heat capacity inherent in gases by efficient transfer of heat at various parts of the process.

Embodiments of the present disclosure will be further described by reference to the following examples. The following examples are merely illustrative and are not intended to be limiting. Unless otherwise indicated, all parts are by weight.

Embodiments of the present disclosure provide advantages over systems employing conventional circulating fluidized beds. In certain embodiments, the circulating fluidized bed may be a hot gas, rather than steam, generator which may be capable of burning multiple types and combinations of fuels. Non-limiting embodiments enable the use of alternative and lower cost fuels, such as, for example, biomass sources, that provide efficient and low-cost energy with very low emissions and environmental impact. The cleaned hot gas produced in the process can be used in various process equipment that allow for flexibility and efficiency in numerous manufacturing processes. Because hot gas, and not steam, may be produced, pressure and/or boiler parts are not necessary in the system design of the present disclosure. In certain embodiments, the circulating fluidized bed hot gas generator of the present disclosure provides a heat source to a closed-loop superheated steam flash dryer to use exhaust steam bleed-off from the super-heated steam flash dryer to provide a heat source to other operational units, such as those of an ethanol plant

In other embodiments, the circulating fluidized bed hot gas generator can be employed as a thermal oxidizer for a superheated steam flash dryer and other VOC emitting sources in manufacturing facilities, such as an ethanol plant. Other embodiments reduce the manufacturing costs associated with the systems of the present disclosure, such as by reducing the need for amount of pollution control equipment. Coupled with a superheated steam flash dryer, embodiments of the present disclosure provide for reuse of dryer exhaust steam, thereby reducing dryer costs

Although the foregoing description has necessarily presented a limited number of embodiments, those of ordinary skill in the relevant art will appreciate that various changes in the components, details, materials, and process parameters of the examples that have been herein described and illustrated in order to explain the nature of certain embodiments may be made by those skilled in the art, and all such modifications will remain within the principle and scope of the invention. It will be understood by those skilled in the art that the particular description and advantages of the present disclosure as set forth herein are illustrative only, and that other uses and advantages may be employed therewith. All such additional applications of certain embodiments remain within the principle and scope of the invention as embodied in the claims. It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the claims.

We claim:

1. A system for using heat to process an agricultural product, comprising:
a circulating fluidized bed combustor comprising
a combustion chamber configured to combust a fuel to generate a mixture comprising hot gases and particulate matter, and
a separation chamber configured to separate at least a portion of the particulate matter from the mixture to form a flow of cleaned hot gas;
a first conduit system configured to conduct the cleaned hot gas to a heat exchanger; and
an indirect heating dryer in heat conductive contact with the heat exchanger and configured to use the heat from the cleaned hot gas to indirectly dry the agricultural product without contacting the agricultural product with the cleaned hot gas.

2. The system of claim 1, wherein the fuel comprises a source selected from the group consisting of biomass, coal, petroleum-coke, tire scrap, and any combination of at least two thereof.

3. The system of claim 2 wherein the fuel further comprises natural gas.

4. The system of claim 1 wherein the fuel comprises a biomass selected from the group consisting of a wood derived material, a dried waste water material, a dried post-fermentation biomass, an organic stillage, an agriculturally derived material, and combinations of any thereof.

5. The system of claim 4 wherein the agriculturally derived material comprises a dried portion of at least one of soybean, cocoa, oat, corn, wheat, canola, and combinations of any thereof.

6. The system of claim 4, wherein the biomass comprises a component of corn.

7. The system of claim 6, wherein the corn component is selected from the group consisting of corn germ, corn starch, corn fiber, corn kernels, corn silk, corn hulls, corn husks, corn stover, corn meal, corn gluten, shelled corn, corn screenings and combinations of any thereof.

8. The system of claim 4 wherein the dried post fermentation biomass comprises distillers dried grains.

9. The system of claim 2, wherein the biomass provides no greater than 50% of the BTU content of the fuel and the remaining fuel content comprises at least one of natural gas and coal.

10. The system of claim 9, wherein the biomass is a combination of a corn component and coal having a corn to coal BTU ratio in the range of 1:20 to 1:1.

11. The system of claim 10, wherein the corn to coal BTU ratio is about 1:1.

12. The system of claim 1, wherein the mixture of hot gases and particulate matter is generated at a temperature ranging from about 843° C. to about 899° C.

13. The system of claim 1, wherein the separation chamber comprises a cyclonic flow chamber comprising:
an upper cylindrical portion configured with a roof, an inlet port to receive the mixture of hot gases positioned at an upper portion of the cylindrical portion, an outlet port positioned above the inlet port to output the cleaned hot gas; and
a lower cone portion in fluid connection with the upper cylindrical portion with an exit port positioned at a lower portion of the cone portion to conduct the particulate matter to the combustor.

14. The system of claim 13, wherein the inlet port is configured to introduce the mixture of particulate matter and hot gases into the cyclonic flow chamber in a direction approximately tangential to the curvature of the cylindrical portion.

15. The system of claim 14 wherein a height to width ratio of the inlet port is 1.5:1 or less.

16. The system of claim 13, wherein the roof has a helical curvature.

17. The system of claim 16 wherein the outlet port is positioned in the roof.

18. The system of claim 13, wherein the cone portion has a length at least twice the diameter of the cylindrical portion.

19. The system of claim 1, wherein the flow of cleaned hot gas is conducted from the separation chamber into the first conduit system at a velocity of at least 3000 ft/minute.

20. The system of claim 1, wherein a thermal energy flow from the combustor to the indirect heating dryer is at least 10 million BTUs per hour.

21. The system of claim 20, wherein the thermal energy flow is between 300 million and 400 million BTUs per hour.

22. The system of claim 1, wherein the agricultural product composes a product derived from at least one of soybean, cocoa, oat, corn, wheat, canola, and combinations of any thereof.

23. The system of claim 1 wherein the agricultural product is selected from the group consisting of distillers dried grain, corn germ, corn starch, corn fiber, corn kernels, corn silk, corn hulls, corn husks, corn stover, corn meal, corn gluten, and combinations of any thereof.

24. The system of claim 1, wherein the separation chamber is further configured to return the separated particulate matter to the combustion chamber via a loop seal in fluid connection between a lower portion of the separation chamber and a lower portion of the combustor.

25. The system of claim 24 wherein the fuel comprises a mixture of coal and biomass and the biomass is introduced into the combustor via a biomass inlet port positioned in the loop seal while the coal is introduced into the combustor via a separate coal port on the combustor away from the biomass port.

26. The system of claim 1 wherein a hot water vapor is produced in the indirect heating dryer and wherein the system further includes a second conduit system configured to conduct the hot water vapor from the indirect dryer to a second heat exchanger configured to provide a processing heat for producing a second agricultural product.

27. The system of claim 26, wherein the hot water vapor is produced at a temperature ranging from 90° C. to 212° C.

28. The system of claim 26, wherein the hot water vapor is used to provide heat to at least one of a distillation apparatus, a dryer, an evaporator, another heat exchanger, a fluid processing stream, or a combination of any thereof.

29. The system of claim 26 wherein the agricultural product comprises distillers dried grains and the second agricultural product comprises ethanol, and wherein the second heat exchanger is configured to heat a distillation apparatus in which the ethanol is produced.

30. The system of claim 26 wherein the agricultural product comprises distillers dried grains and the second heat exchanger is configured as an evaporator.

31. The system of claim 1 wherein the combustion chamber is cylindrical.

32. The system of claim 1, wherein the combustion chamber further includes a top portion and an outlet port concentric with the cylinder located in the top portion to conduct the mixture of particulate matter and hot gases into the separation chamber.

33. A fluidized bed combustor system, comprising:
a cylindrical combustion chamber configured to combust a fuel to generate a mixture comprising hot gases and particulate matter, and which is devoid of contact between the hot gases and a water containing conduit; and
a cyclonic air flow separation chamber in fluid connection with the combustion chamber and configured to separate at least a portion of the particulate matter from the mixture to form a first flow of cleaned hot gas that is conducted away from the cyclonic air flow chamber and combustion chamber, and to return the separated particulate matter to the combustion chamber.

34. A continuous system for using heat to process an agricultural product, comprising:
a circulating fluidized bed combustor comprising
a combustion chamber configured to combust a fuel to generate a mixture containing hot gases and particulate matter, and
a separation chamber configured to separate at least a portion of the particulate matter from the mixture to form a flow of cleaned hot gas, the separation chamber further comprising a return conduit that is configured to return at least a portion of the separated particulate matter to the combustion chamber;
a first conduit system configured to conduct the cleaned hot gas to a heat exchanger; and
an indirect heating dryer in heat conductive contact with the heat exchanger and configured to use the heat from the cleaned hot gas to indirectly dry the agricultural product without contacting the agricultural product with the cleaned hot gas,
wherein a hot water vapor is produced in the indirect heating dryer and wherein the system further includes a second conduit system configured to conduct the hot water vapor from the indirect dryer to a second heat exchanger configured to provide heat for further processing.

35. A method of employing heat to process an agricultural product, comprising:
combusting a fuel in a circulating fluidized bed combustor comprising
a combustion chamber configured to combust a fuel to generate a mixture comprising hot gases and particulate matter, and
a separation chamber configured to separate at least a portion of the particulate matter from the mixture to form a flow of cleaned hot gas;
to generate a mixture containing hot gases and particulate matter;
separating at least a portion of the particulate matter from the mixture to form a flow of cleaned hot gas;
conducting the cleaned hot gas to a heat exchanger; and
indirectly drying the agricultural product with the cleaned hot gas without contacting the agricultural product with the cleaned hot gas.

36. An agricultural product processing plant configured to perform the method of claim 35.

37. A corn wet milling plant configured with the system of any one of claims 1-34.

38. A corn dry milling plant configured with the system of any one of claims 1-34.

39. Any of the systems according to claims 33 and 34 configures according to any of claims 2-32.

40. The method according to claim 35 combined with any of the systems according to claims 1-34.
